(19) United States
(12) Patent Application Publication
(10) Pub. No.: US 2016/0239641 A1
(43) Pub. Date: Aug. 18, 2016

(54) Method and System for Scan and Matching Media for Streaming Authorization

(71) Applicants: Jean Lafleur, San Francisco, CA (US); Jonathan Benassaya, San Francisco, CA (US)

(72) Inventors: Jean Lafleur, San Francisco, CA (US); Jonathan Benassaya, San Francisco, CA (US)

(21) Appl. No.: 14/832,921

(22) Filed: Aug. 21, 2015

Related U.S. Application Data
(60) Provisional application No. 62/117,859, filed on Feb. 18, 2015.
(60) Provisional application No. 62/208,420, filed on Aug. 21, 2015.

(51) Int. Cl. G06F 21/10

(52) U.S. Cl. CPC G06F 21/10; G06F 2221/0711; G06F 2221/0708

(57) ABSTRACT

This invention discloses a novel system and method for authorizing streaming of content to a user by verifying that a user possesses a media product that contains the content, where such verification relies on obtaining an image of the media product and analyzing the image to determine that it is not a picture of a computer screen displaying a picture of the media product, and relying on the picture of the media product being captured at a time when the user is verified to be located at a predetermined authorized location.

### PRIORITY CLAIM

This application claims priority as a non-provisional continuation to U.S. Provisional Patent Application No. 62/117,859 filed on Feb. 18, 2015, which is hereby incorporated by reference in its entirety. This application also claims priority as a non-provisional continuation of U.S. Provisional Patent Application No. 62/208,420 filed on Aug. 21, 2015, which is hereby incorporated by reference in its entirety.

### FIELD OF INVENTION

The present invention generally relates to the field of streaming music, movies, television shows and other content from a website to multiple users who have accounts with the service operating the website. The present invention is related to a process and system that automatically verify if the user possesses a bona-fide hard-copy version of a piece of media, for example, a DVD, Blu-Ray or CD, or even a vinyl record. The verification process authorizes the user to receive streams of the content that is embodied on the media item.

### BACKGROUND

The internet introduced the ability for consumers to enjoy content selected at their leisure at times of their choosing. This was a major departure from traditional broadcast television and radio, where a central network selected content and broadcast the content at arbitrary times. Over the last several years, many services have become available for delivering music, movies, television episodes to individual users from websites that maintain large libraries of content that may be selected by individual users and transmitted to the user when the user makes the selection. For example, Netflix™ and Amazon™ offer such services. These services have only become practical recently as a result of homeowners obtaining access to sufficiently high bandwidth Internet connections required to practically sustain such a delivery mode and now some cell phone services providing such bandwidth to mobile devices. A key aspect of the services are that the services do not deliver a single, fixed file embodying the content that is transferrable among consumers in the same manner that a DVD disk or CD disk can be transferred from one person to another. Rather, the transmissions of content are made in near-real-time, as the performance of the content progresses. Once data has been received by user's computer device and displayed or played back, the data is not retained. This type of transmission is typically referred to as “streaming.” However, streaming services include services that deliver an actual downloaded copy of the content that is stored on the user's device in a way that makes it inaccessible to the user, but accessible to the playback program. This approach is often referred to as streaming as well, but in a manner that alleviates problems introduced by interrupted bandwidth. In either type of streaming, the content data is transmitted to the user's computing device. As the public becomes more accustomed to streaming content rather than owning their own copy, there is increased demand for the streaming service to deliver a variety of content to a variety of the user's devices. In addition, many users seek to have copies of content they already own in hard-copy form, for example as DVD, Blue Ray or CD, or even old vinyl records, to be available from their streaming service in order that such content be available to their range of devices. Any system that provides this functionality has to provide the functionality in a secure manner in order that it not become an avenue of content piracy, which has been observed with prior-art services like mymp3.com. As a result, there is a need for a mechanism that permits a streaming service to automatically determine if a user is a bona-fide owner of a hard-copy media.

### DESCRIPTION OF THE FIGURES

The headings provided herein are for convenience only and do not necessarily affect the scope or meaning of the claimed invention. In the drawings, the same reference numbers and any acronyms identify elements or acts with the same or similar structure or functionality for ease of understanding and convenience. To easily identify the discussion of any particular element or act, the most significant digit or digits in a reference number refer to the Figure number in which that element is first introduced (e.g., element 204 is first introduced and discussed with respect to FIG. 2).

FIG. 1. Flowchart of scan and authorization process

FIG. 2. Example user data structure diagram

FIG. 3. Flowchart for verification phase

FIG. 4. Flowchart for activation and verification

FIG. 5. Example screenshot of scanner program capturing barcode

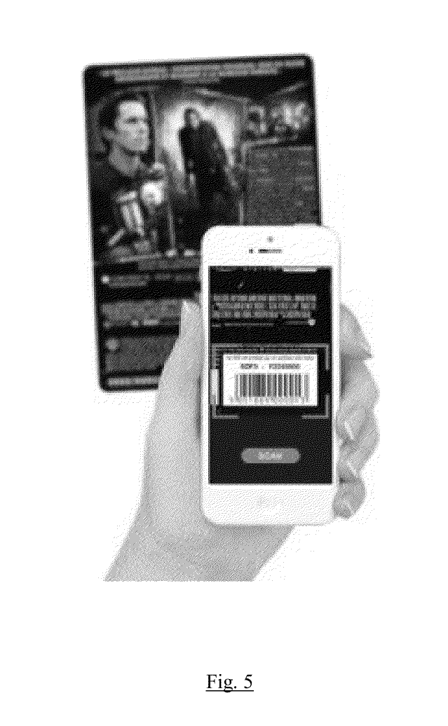

FIG. 6. Example screenshot of scanner program identifying barcode.

FIG. 7. Example screenshot of verification request to authorized operator

FIG. 8. Pattern of magnified image of white region of a computer screen

FIG. 9. Pattern of brightness of magnified image of computer screen

FIG. 10. Flowchart showing further detail for scanning validation process.

FIG. 11. Flowchart for user verification using credit card billing address.

### DETAILED DESCRIPTION

Various examples of the invention will now be described. The following description provides specific details for a thorough understanding and enabling description of these examples. One skilled in the relevant art will understand, however, that the invention may be practiced without many of these details. Likewise, one skilled in the relevant art will also understand that the invention can include many other features not described in detail herein. Additionally, some well-known structures or functions may not be shown or described in detail below, so as to avoid unnecessarily obscuring the relevant description. The terminology used below is to be interpreted in its broadest reasonable manner, even though it is being used in conjunction with a detailed description of certain specific examples of the invention. Indeed, certain terms may even be emphasized below; however, any terminology intended to be interpreted in any restricted manner will be overtly and specifically defined as such in this Detailed Description section.

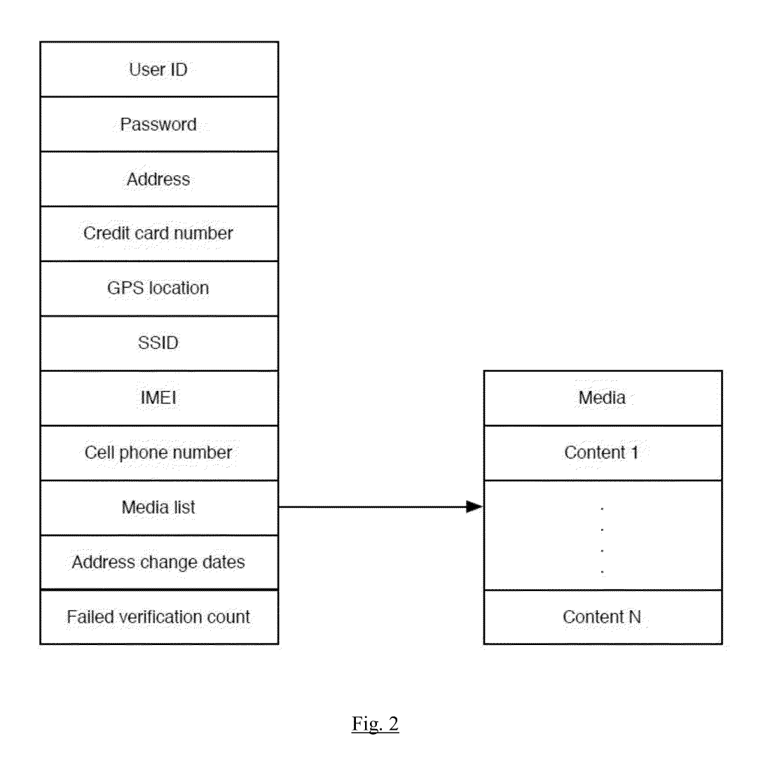

Content may be owned by a user in a variety of source formats. For example, there may be disks, like a DVD, BluRay or CD. Alternatively, the user may own a DRM (Digital Rights Management) protected content data file residing on their own computer or data storage device, for example, a downloaded music file in the encoding and container format used by iTunes™. A user of the method and system is registered in a database operated by the server. The user's data record can contain login credentials and other data necessary to verify the authority of the user to use the system. This information can includes a username, password, home address, IP address, IMEI number of the user's cell-phone, the cell phone number and any other identifying information that is usable to verify the authenticity of the user. See FIG. 2. In addition, the user's data record includes a list of content that the system has verified is associated with the user, or, a list of media items, which can point to a media item record that contains a list of content. As the user operates the system and thereby obtains additional media authorization data, the list of authorized media and thereby content authorized for streaming to that user's devices is lengthened. In the preferred embodiment, a special program (referred to herein as the “scanner program”) is downloaded onto the cell phone or other device and operated by the user.

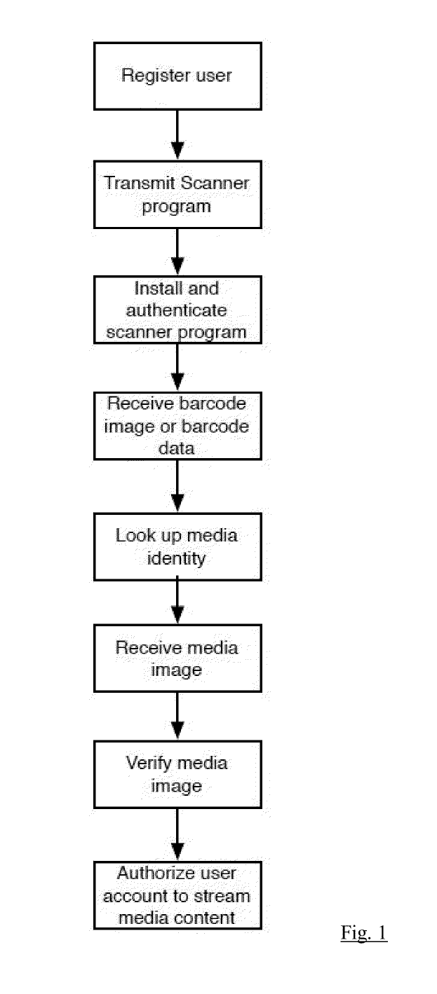

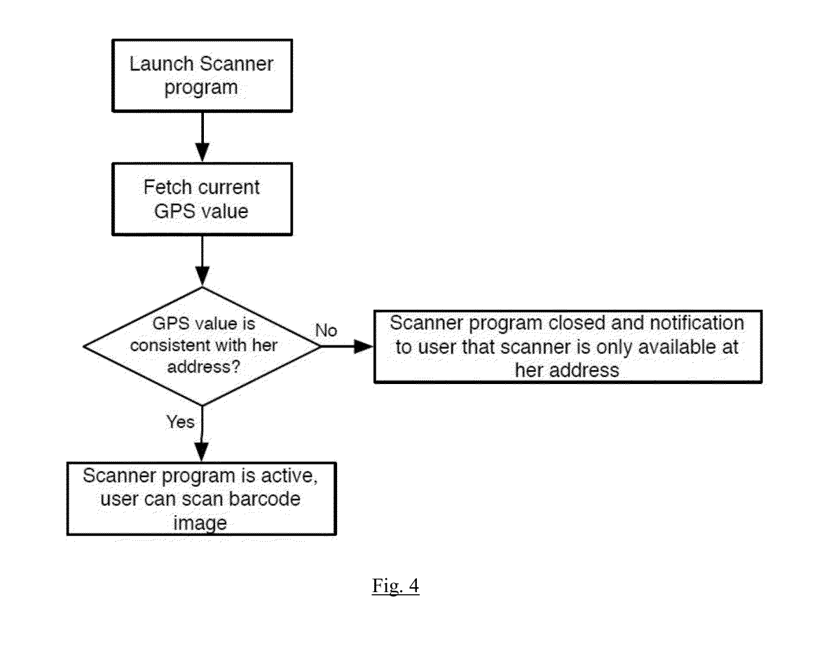

The first phase of the system's operation is the activation of the scanner program operating on the user's cell phone, laptop or other computer device. See FIG. 1. First, the user logs into the system in order to request a download of the scanner program onto their device. Alternatively, a generally available application or “app” may be provided from third party computer program sites, like the ITunes™ app-store™. When the user activates the scanner program, they have to provide their user credentials to the program. The program then operates a secure communication protocol with the server that verifies that the cell-phone number, IMEI number or other identifier in the cell phone matches with the user's credentials. The server receives the IMEI number or cell phone number and user credentials transmitted by the scanner program, and then looks up in the user data record associated with the user credentials to see if the IMEI number or cell phone number match the data in the data record. If they do, then this verification step is passed. The very first time the user registers with the system, the IMEI number captured by the scanner program is saved in the user's data record. The next step in establishing security is to utilize the expectation that a user would use such a function in their home, where they store their hard-copy media. As a result, the scanner program running on a cell phone would utilize the cell phone localization services to obtain the location of the user's cell phone and transmit that information to the server. The server would then check that the localization data is consistent with the user address present in the database record associated with the user. In an alternative embodiment, the database data can be transmitted to the cell phone and the scanner program can perform the localization test. The activation phase then requires that the scanner program verify that it is being used in an authorized location, or else it fails to operate. See FIG. 4, (401).

One security threat would be a user that changes their address to some arbitrary address in order to spoof the system. This threat model can be addressed by the server requesting an address verification by means of a credit card processing service. In this manner, the localization data can be mapped to a zip code and then the zip code transmitted to a credit card service with the user's credit card (that may be stored in the user's data record in the database) in order to see if the credit card service is satisfied that the zip code matches the user. In that case, the system will receive from the credit card processing service a data message indicating an approval. The server, upon detecting that it received such an approval for that user, can update the user's data record accordingly to indicate that it is in an authorized state. If a person cannot provide a credit card number, then the user may still be able to use the service by transmitting a scan image of a utility service bill for their home to the server, and the server then presenting the image to an authorized person who can then approve that image as a form of authenticating the user's location.

In yet another embodiment, the system is adapted so that the scanner program can only operate at a specific location associated with the user. (401). In this embodiment, scanner program can utilize the user's device's GPS location capability to directly capture the location of the user's cell phone with GPS and transmit that data to the server. The server can run a program that determines if a given GPS location is consistent with the user's address. If so, then the user has passed this verification test. See FIG. 4 (401). In another embodiment, geolocation can be confirmed by combining the device's reported GPS location and the SSID of one or more WiFi networks detected by the device. In this embodiment, when the user first uses the scanner program, it can capture the GPS data and transmit the data to the server so that the server can populate the data record associated with the user. These two values can be stored in the data record associated with the user. The scanner program, during activation, can fetch the two values and transmit them to the server for verification. Verification in this case would involve comparing the GPS values and determining if the two values are within an acceptable distance tolerance, for example, within the confines of the same house. In yet another embodiment, the localization data can be derived from cellular telephone location data, which may provide location data that is not specifically GPS. Upon verification of the user's location, the server can then transmit to the scanner program operating on the user's device an authorization token value representing the logic state that the scanner program is authorized to operate.

In some embodiments, the system is adapted so that the user may change their authorized home address by submitting independent forms of proof for verification, for example, by transmitting a utility bill in their name that has the new address. The scanned image of the bill can be transmitted to a computer operated by an authorized operator of the system, who can then input into the computer a command approving the change in address based on the operator's visual inspection of the scanned document. The computer can transmit the input value back to the server, and the server, in response to receiving the confirmation, can update the user's data record with the new address. The system can maintain a time value in the data record that automatically stores an automatically incrementing time value measuring the time period from the user's prior address change. When an address change submissions is made, the system can check whether the date of such a submission is within a pre-determined period of time from the prior address change submission, for example one-year. If the system determines that such is the case, the user's account can be temporarily suspended from delivering streams and further verification of the new address can be instituted. One example of further verification can be the submission of a second utility bill or some other bill or credit card processor confirmation that uses the new address. In any case, once the scanner program has been authorized, it is ready for use in identifying hard-copy media.

In the second phase, the content is mounted and identified by a process operating on the computer. For example, a user may place a DVD in the optical drive of their computer. A program operating on the user's computer can fetch a predetermined amount of data from the disk by reading the data off of the disk from predetermined locations. This data may be transmitted to a server in the form of a request for identification. In one embodiment, the disk data may embody an industry standard identifying code, like the ISRC code used in the music business. In another, some of the audio data on the disk may be used by a music fingerprinting service to directly determine the source of the audio, for example, by using the Gracenote™ service. These techniques may be improved or assisted by the user inputting into a user interface of the program the title of the disk, if it is known. In this embodiment, the scanner program can access the media directly and obtain a pre-determined set of data from the disk. The scanner program can then transmit this data to the server for identification. Other electronic data items that may indicate ownership of a media product include electronic receipts of purchase, such as email receipt from Vudu™, Amazon™ or iTunes™. In this embodiment, the scanner program is inspecting media content itself or evidence of its purchase in order to transmit data to the server for an authorization. Examples of electronic receipt scanning processes are described in U.S. Provisional Patent Application No. 62/208,420 filed on Aug. 21, 2015 and incorporated herein by reference.

In yet another embodiment of the invention, the identity of the hard-copy media can be confirmed by use of bar-code scanning. In this embodiment, the user can use their cell phone, for example, an iPhone™ to capture a picture of the bar-code on the cover of the hard-copy media product. The scanner program can automatically operate the camera functionality on the phone and capture the image. This provides a level of security in that the image captured by the program is known to be from the camera on the cell phone and not an arbitrary image file. The program operating on the cell phone can transmit to the server the identity of the user and the bar-code image. In yet another embodiment, the image that is captured is of the entire cover of the hard-copy media product. The scanner program download can contain a unique identifier data value in its payload that is associated with that specific user on the server. The scanner program can also incorporate into the image file that is uploaded that identifier, or another number that can be uniquely associated with the identifier so that any image file can be inspected to determine which user's version of the scanner program produced the image. This enhances security of the system.

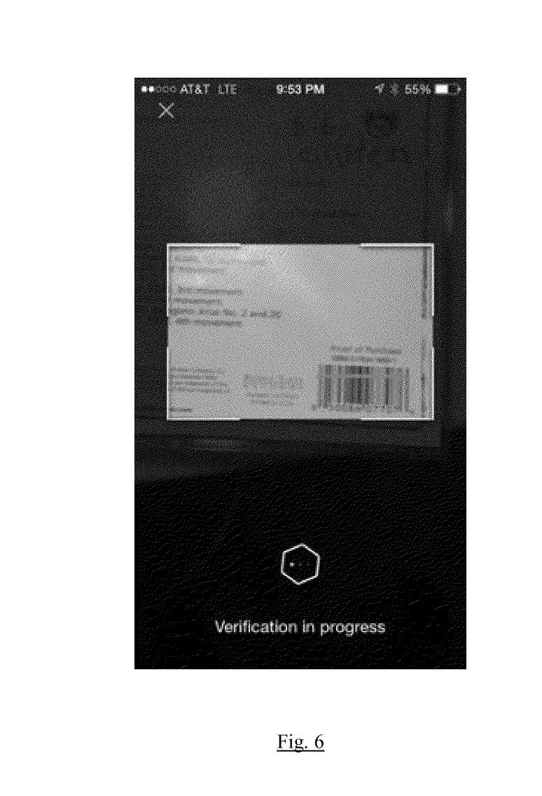

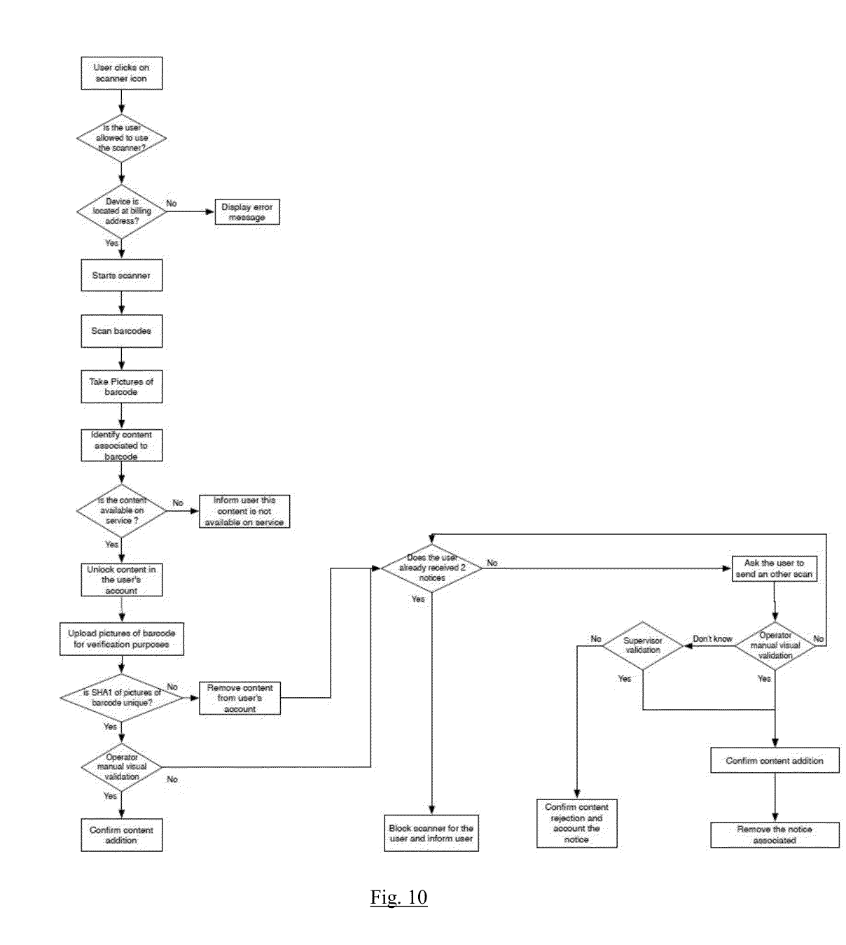

The scanner program operating to capture bar-codes is programmed to recognize typical bar-code standards, for example, EAN 8 and EAN 13. The scanner program operating on a cell phone or other mobile device can be adapted so that it does not operate when scanning a bar-code from another computer screen. This capability prevents another spoofing attack on the integrity of the system, whereby a user attempts to demonstrate ownership of a hard-copy of media by attempting to scan an image of the media as a catalogue item on a website. In operation, the scanning program captures at least one picture of the cover of the hard-copy media that includes its bar-code. The scanner program then displays the image that it captured with a blue colored (or other colored) line shown depicting the scan across the bar code. See FIG. 6 and FIG. 10. The scanner program can be further adapted to cause the cell phone to ring or vibrate when the bar-code has been captured. In the background, the mobile device preferable takes several pictures. The captured bar-code may be transmitted to the server for verification. The several pictures can be processed on the mobile device or transmitted to the server for verification.

The third phase of the method and system is the identification process. This phase involves automatically identifying the hard-copy media captured by the scanner program and verifying that the user is a bona-fide owner and is not spoofing the system. When the scanner program transmits the requests for an identification of the media item, the server transmits back to the scanner program alpha-numeric text listing the identity of the content. Upon such receipt, the scanner program user interface displays a window confirming to the user the identification of the content.

On the server, once the identity of the media has been identified, the user's data record is updated to include one or more identifiers uniquely associated with media item or the content items present on that media. In another embodiment, the user's data record is updated with an identifier associated with the media item. The server then, upon displaying the content available to the user, uses the media identifier to query a media database (described below) to obtain the list of authorized content. At that point, the user, upon logging into the service directly, can see that the user is authorized to receive a stream of such identified content. The user, operating the server application directly, can then select from a list of content associated with the user's account. The server transmits at least part of the list of content for display on the user's device, the user inputs a command indicating a selection of content on the list and then the user's device transmits to the server data representing the selection. The server receives data representing the selection choice and then uses that selection data to initiate a stream session between the server and the user's device for the selected content.

The identification of submitted data extracted from the media or captured from an image of the media requires several steps. For extracted data, the server can formulate a request to external databases that are adapted to receive requests containing data extracted from disks, and then return identity information. One example is the Gracenote™ service, which receives certain audio data and uses that data to search a database that maps audio data to media and content identifiers. This direct approach identifies the content on the basis of the content data itself. In another embodiment, the server can be comprised of a database of media items, associated bar-codes and a list of content present on such media. In this embodiment, the server receives an image containing a bar-code, and extracts the bar-code or it receives the bar-code itself. The bar-code is embedded into a database query into the media database. If there is a bar-code match, the database returns an identifier associated with the media.

In some cases, the server will receive an image from the user's device and cannot discern a proper bar-code or no bar-code at all. In this case, the verification may be considered uncertain and a second layer of verification is activated. In this case, the user's data record is not updated to include the scanned media as authorized for scanning Rather, the media item is tagged as pending. In one embodiment, if the scan of a bar-code is confirmed as uncertain the user will receive an email asking for a photo of the media or disk. The entire image of the media item can be used to create a fingerprint code associated with the media cover. When the user uploads an image of the media item, the image can be automatically processed to extract features in the image that can be used to identify it. In one embodiment, the image can be converted by two-dimensional Fourier transform into a series of numbers that represent the image. In another embodiment, histograms of the primary colors can be used. In the media database, each piece of media, which has a data record, can include a series of these numbers. The server can then match the incoming image with an image in the database by looking for fingerprint numbers that are sufficiently close, within a predetermined tolerance to select at least one candidate media identification. This can be accomplished by calculating a convolution between the detected finger print data and the finger print data in the database, and determining if the convolution result is sufficiently close, within a predetermined tolerance value, to indicate a high probability of a match.

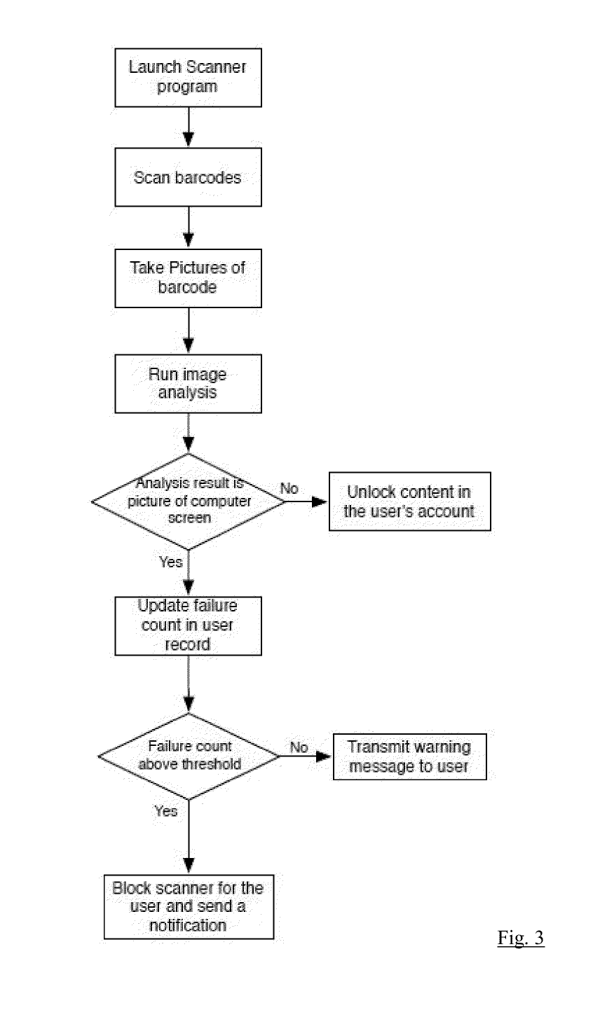

The fourth phase of the method and system is the verification that the image of the media item is an actual image of the item, and not a spoof of the system. See FIG. 3. This threat model is that a user may attempt to submit a picture of the item that is displayed on a computer screen instead of having the scanner program directly photograph the actual item. To address this threat model, whether extracted data is used to identify the item, or a bar-code, in either case the image data is used to confirm that the actual item is present with the user. The scanner program automatically takes one or more images in a manner designed to verify that the images are of an actual object. These one or more images may be transmitted to the server so that the server system can verify that they are images of the media item in front of the camera of the user's mobile device.

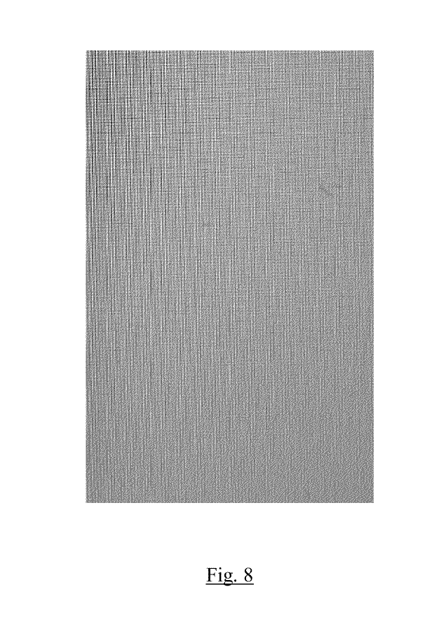

The verification of the image of the media item can be accomplished in several ways. In one embodiment, the server system operates a program that analyzes the image data representing the picture of the media item. This embodiment exploits a distinction between a display on a digital screen and a display on a DVD cover based on the color noise of digital screens. Every digital screen displays a pattern as they display colors based on the RGB (Red Green Blue) colors. A photograph of a white color region on a digital screen, when magnified sufficiently, will show a series of red, green and blue pixels at the resolution of the screen, not the higher resolution of the digital camera. See FIG. 8. An image of a high-quality print of a CD or record cover does not have this property because high-quality printing uses CMYK inks in a variety of patterns.

In this embodiment, the verification program obtains the image containing the barcode of the media item. The bar-code typically has a white background. The verification program then inspects the individual pixel values in the image along a one-pixel wide horizontal scan line.

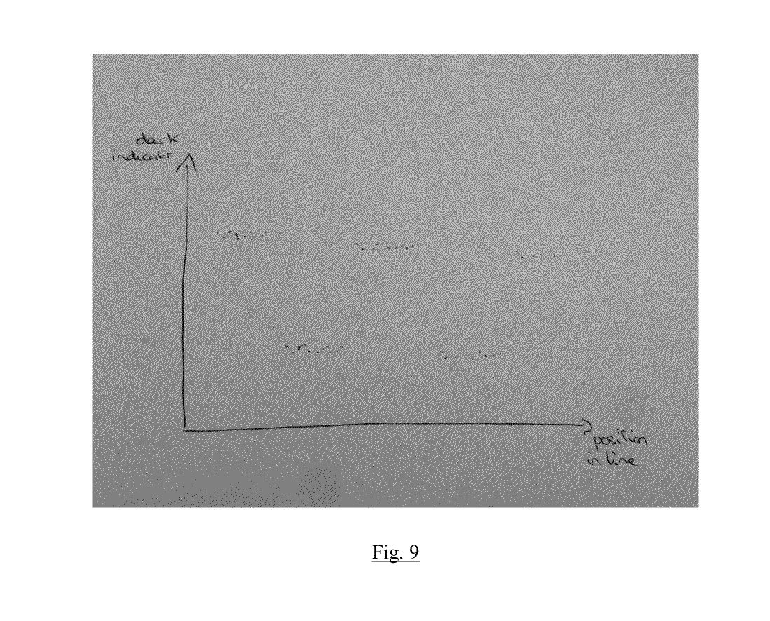

The program selects a region of the scan line between the black bar-code lines. The pixel values along this line are inspected by the program to determine if the intensity values show a periodic variation pattern. One pattern can be that the pixel values in the digital image show a high brightness magnitude followed by a low brightness magnitude in a regular, repetitive way. The program can use convolution of a step function as a way to detect the presence of such a pattern. If the colors for each pixel of this line displays a pattern similar to that in FIG. 9, this means that there is a regular pattern which can only come from a digital screen. In this case, the verification for that submission of media for that user fails.

In another embodiment, the server analyzes the color noise in the image and takes advantage of a distinction between the color noise on a high quality printed copy of a DVD cover and a display of a DVD cover on a computer screen. In addition, any low quality picture and print out of the DVD cover will display a similar pattern.

In yet another embodiment, the verification takes advantage of the distinction between a display on a digital screen and a display on a DVD cover based on the flickering of the screen. Digital display screens flicker at frequencies of around 50 Hz or 60 Hz in general. So if with a camera, the scanner program takes 61 pictures every 1/61^{st} of a second apart (or some other prime number), then there will be at least one image in the set that is a picture of the flicker. The selection of 61 arbitrary and the same effect would be observed with 31 images taken 1/31th of a second apart. The selection of the number of images is that it should preferably be a rime number and the number that is one divided by the screen flicker frequency is not multiple of it. The process would consist of the following:
a. When scanning the barcode, take 31 pictures at a 31 frames per second.
b. Inspect the 31 images to determine if any image shows a substantial darkening of the display.
   This can be accomplished by calculating the average luminosity of each of the images and determining if any one of the images is an outlier from the average beyond a predetermined tolerance. If any of the images is such an outlier, the conclusion is that the picture is of a computer screen, not the actual object.

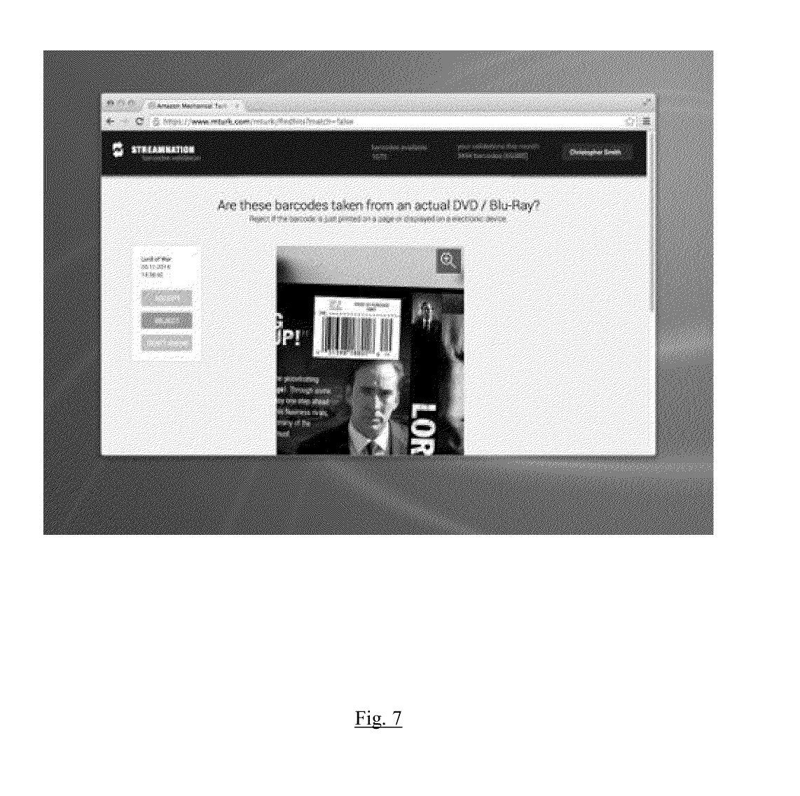

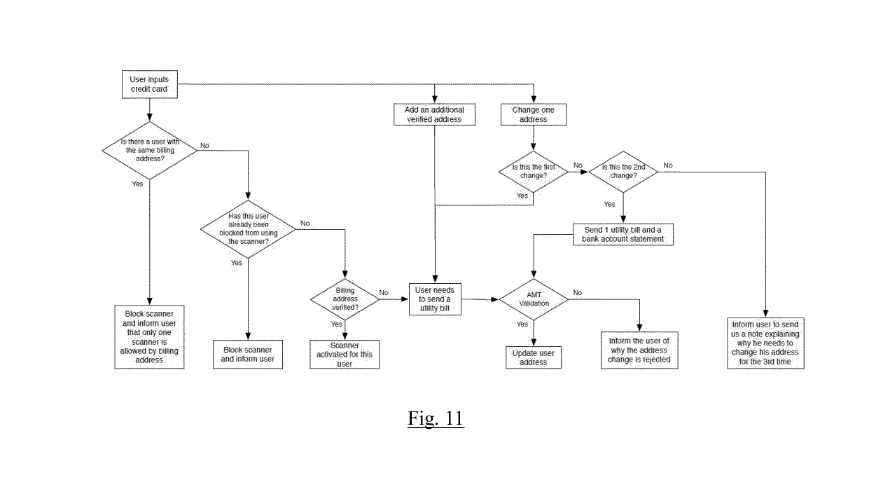

In yet another embodiment, verification of the image can be accomplished by inspection by the authorized operator of the system. In this embodiment, the image received from the user's device can be transmitted to a computer operated by an authorized operator and displayed on the screen of that authorized operator's computer. The image can be transmitted to the operator with a request code that is associated by the system server with the user's submission of their scan of the media item. See FIG. 7. The operator can then evaluate the image and input into their computer a data value representing their determination that the image is either bona-fide or a spoof. The operator's computer can then receive the operator's input and transmit back to the server the operator's input and the request code that the operator's computer received from the server. See FIG. 11. This server can then use the received request code to update the appropriate data record in the user database by mapping the request code to the user's data record. At that point, the server can update the record to encode the state of the verification either being successful or a failure.

If the verification step results in a failure, the user's data record is updated to reflect that fact. For example, the bar-code number or title input by the user can be stored with a flag that the verification failed, and the date of failure or the failure count. In one embodiment, if the failure is the first for the user, then the server will extract from the user's data record their email address, compose an email object automatically with that email address as the destination and transmit that email object to the user at the email address indicated. The email message can contain text data embodying a warning, and the warning can reference the media title identified by the system. In any case, the user's account will not be set to be authorized to receive a stream of any content contained on that media item. The server can also be adapted so that upon a failure, it checks to see if the user's data record already contains a first failure warning notice. If so, the server can automatically delete the user's account from the system. In an alternative embodiment, the user's account is preserved, but set to an invalid status. This makes it possible to prevent a user from re-enlisting with the service because the server, upon the scanner program activating, can check whether the same user identification data is associated with an invalidated user. In this case, the scanner program will not activate.

Once the media item is verified, the user's data record on the server is updated to include an identifier associated with the media item and a status flag that the media item is authorized for streaming, as further describe above. When the user logs into the server system independently of the scanning program, and selects content authorized for streaming, the server receives the input from the user designating the content to be streamed and initiates such a stream to the IP address from where the login credentials came. The stream is preferably delivered in HD, that is H.264 format.

Operating Environment: The system is typically comprised of a central server that is connected by a data network to a user's computer. The central server may be comprised of one or more computers connected to one or more mass storage devices. The precise architecture of the central server does not limit the claimed invention. In addition, the data network may operate with several levels, such that the user's computer is connected through a fire wall to one server, which routes communications to another server that executes the disclosed methods. The precise details of the data network architecture does not limit the claimed invention. Further, the user's computer platform device may be a laptop or desktop type of personal computer. It can also be a cell phone, smart phone or other handheld device. The precise form factor of the user's computer platform device does not limit the claimed invention. Further, the customer may receive from and transmit data to the central server by means of the Internet, whereby the customer accesses an account using an Internet web-browser and browser displays an interactive web page operatively connected to the central server. The central server transmits and receives data in response to data and commands transmitted from the browser in response to the customer's actuation of the browser user interface. The program can detect the relative location of the cursor when the mouse button is actuated, and interpret a command to be executed based on location on the indicated relative location on the display when the button was pressed. Similarly, the program can detect the location of a touch on the screen. The data file may be an HTML document, the program a web-browser program and the command a hyper-link that causes the browser to request a new HTML document from another remote data network address location. The data file may also contain scripts, which are computer program commands, which are executed by the browser. The data file may also contain references to objects stored either locally or remotely that the browser may then access and display or otherwise render. The browser can thereby fetch additional data that is stored on a remote server accessed using the Internet.

The Internet is a computer network that permits customers operating a personal computer to interact with computer servers located remotely and to view content that is delivered from the servers to the personal computer as data files over the network. In one kind of protocol, the servers present webpages that are rendered on the user's computer platform using a local program known as a browser. The browser receives one or more data files from the server that are displayed on the customer's personal computer screen. The browser seeks those data files from a specific address, which is represented by an alphanumeric string called a Universal Resource Locator (URL). However, the webpage may contain components that are downloaded from a variety of URL's or IP addresses. A website is a collection of related URL's, typically all sharing the same root address or under the control of some entity.

A server may be a computer comprised of a central processing unit with a mass storage device and a network connection. In addition a server can include multiple of such computers connected together with a data network or other data transfer connection, or, multiple computers on a network with network accessed storage, in a manner that provides such functionality as a group. Practitioners of ordinary skill will recognize that functions that are accomplished on one server may be partitioned and accomplished on multiple servers that are operatively connected by a computer network by means of appropriate inter process communication. In addition, the access of the website can be by means of an Internet browser accessing a secure or public page or by means of a client program running on a local computer that is connected over a computer network to the server. A data message and data upload or download can be delivered over the Internet using typical protocols, including TCP/IP, HTTP, SMTP, RPC, FTP or other kinds of data communication protocols that permit processes running on two remote computers to exchange information by means of digital network communication. As a result a data message can be a data packet transmitted from or received by a computer containing a destination network address, a destination process or application identifier, and data values that can be parsed at the destination computer located at the destination network address by the destination application in order that the relevant data values are extracted and used by the destination application.

It should be noted that the flow diagrams are used herein to demonstrate various aspects of the invention, and should not be construed to limit the present invention to any particular logic flow or logic implementation. The described logic may be partitioned into different logic blocks (e.g., programs, modules, functions, or subroutines) without changing the overall results or otherwise departing from the true scope of the invention. Oftentimes, logic elements may be added, modified, omitted, performed in a different order, or implemented using different logic constructs (e.g., logic gates, looping primitives, conditional logic, and other logic constructs) without changing the overall results or otherwise departing from the true scope of the invention.

The method described herein can be executed on a computer system, generally comprised of a central processing unit (CPU) that is operatively connected to a memory device, data input and output circuitry (IO) and computer data network communication circuitry. Computer code executed by the CPU can take data received by the data communication circuitry and store it in the memory device. In addition, the CPU can take data from the I/O circuitry and store it in the memory device. Further, the CPU can take data from a memory device and output it through the IO circuitry or the data communication circuitry. The data stored in memory may be further recalled from the memory device, further processed or modified by the CPU in the manner described herein and restored in the same memory device or a different memory device operatively connected to the CPU including by means of the data network circuitry. The memory device can be any kind of data storage circuit or magnetic storage or optical device, including a hard disk, optical disk or solid state memory.

Examples of well known computing platforms, systems, environments, and/or configurations that may be suitable for use with the invention include, but are not limited to, personal computers, server computers, hand-held, laptop, tablet or mobile computer or communications devices such as cell phones, smart phones and PDA's, multiprocessor systems, microprocessor-based systems, set top boxes, programmable consumer electronics, network PCs, minicomputers, mainframe computers, distributed computing environments that include any of the above systems or devices, and the like. These may operate using as an operating system Windows, iOS, OSX, Android, Linux, Unix, Symbian and Blackberry including the various versions and variants thereof.

Computer program logic implementing all or part of the functionality previously described herein may be embodied in various forms, including, but in no way limited to, a source code form, a computer executable form, and various intermediate forms (e.g., forms generated by an assembler, compiler, linker, or locator.) Source code may include a series of computer program instructions implemented in any of various programming languages (e.g., a scripting language, like JAVA, Java Script, an assembly language, or a high-level language such as FORTRAN, C, C++). The source code may be compiled before execution and distributed as object code that is executed on the target computer or compiled as it is executed by the target computer, in each case for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The invention may be described in the general context of computer-executable instructions, such as program modules, being executed by a computer. Generally, program modules include routines, programs, objects, components, data structures, etc., that perform particular tasks or implement particular abstract data types. The computer program and data may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed hard disk), an optical memory device (e.g., a CD-ROM or DVD), a PC card (e.g., PCMCIA card), or other memory device. The computer program and data may be fixed in any form in a signal that is transmittable to a computer using any of various communication technologies, including, but in no way limited to, analog technologies, digital technologies, optical technologies, wireless technologies, networking technologies, and internetworking technologies. The computer program and data may be distributed in any form as a removable storage medium with accompanying printed or electronic documentation (e.g., shrink wrapped software or a magnetic tape), preloaded with a computer system (e.g., on system ROM or fixed disk), or distributed from a server or electronic bulletin board over the communication system (e.g., the Internet or World Wide Web.)

The invention may also be practiced in distributed computing environments where tasks are performed by remote processing devices that are linked through a communications network. In a distributed computing environment, program modules may be located in both local and remote computer storage media including memory storage devices. Practitioners of ordinary skill will recognize that the invention may be executed on one or more computer processors that are linked using a data network, including, for example, the Internet. In another embodiment, different steps of the process can be executed by one or more computers and storage devices geographically separated by connected by a data network in a manner so that they operate together to execute the process steps. In one embodiment, a user's computer can run an application that causes the user's computer to transmit a stream of one or more data packets across a data network to a second computer, referred to here as a server. The server, in turn, may be connected to one or more mass data storage devices where the database is stored. The server can execute a program that receives the transmitted packet and interpret the transmitted data packets in order to extract database query information. The server can then execute the remaining steps of the invention by means of accessing the mass storage devices to derive the desired result of the query. Alternatively, the server can transmit the query information to another computer that is connected to the mass storage devices, and that computer can execute the invention to derive the desired result. The result can then be transmitted back to the user's computer by means of another stream of one or more data packets appropriately addressed to the user's computer.

The described embodiments of the invention are intended to be exemplary and numerous variations and modifications will be apparent to those skilled in the art. All such variations and modifications are intended to be within the scope of the present invention as defined in the appended claims. Although the present invention has been described and illustrated in detail, it is to be clearly understood that the same is by way of illustration and example only, and is not to be taken by way of limitation. It is appreciated that various features of the invention which are, for clarity, described in the context of separate embodiments may also be provided in combination in a single embodiment. Conversely, various features of the invention which are, for brevity, described in the context of a single embodiment may also be provided separately or in any suitable combination. It is appreciated that the particular embodiment described in the Appendices is intended only to provide an extremely detailed disclosure of the present invention and is not intended to be limiting. It is appreciated that any of the software components of the present invention may, if desired, be implemented in ROM (read-only memory) form. The software components may, generally, be implemented in hardware, if desired, using conventional techniques.

The foregoing description discloses only exemplary embodiments of the invention. Modifications of the above disclosed apparatus and methods which fall within the scope of the invention will be readily apparent to those of ordinary skill in the art. Accordingly, while the present invention has been disclosed in connection with exemplary embodiments thereof, it should be understood that other embodiments may fall within the spirit and scope of the invention, as defined by the following claims.

What is claimed:

1. A method for authorizing transmission of digital content data comprising:
receiving from a user's computer data representing the location of the computer;
verifying that the received location is an authorized location;
receiving at least one image file of a media item cover, said media item being associated with the digital content;
determining that the received at least one image file is a picture of the media item cover and not a picture of a reproduction or computer screen display of the media item cover to within
a predetermined verification criteria tolerance; and
in response to the determination, initiating a transmission of the digital content.

2. The method of claim 1 where the verification step is comprised of:
receiving GPS location data; and
determining that the GPS location data is within a predetermined distance tolerance threshold to an address location represented by address data retrieved from a data record associated with the user.

3. The method of claim 2 where the verification step is comprised of:
receiving data representing an address;
receiving a credit card number, said credit card number being associated with an authorized billing address; and
determining if the received address data is comprised of data that matches the authorized billing address.

4. The method of claim 1 where the determining step is comprised of:
analyzing the at least one image file to determine if the image, when magnified, is consistent with a picture of an image displayed on a computer screen.

5. The method of claim 4 where the analyzing step is comprised of:
determining whether at least one approximately white regions of the at least one image file, when magnified, contain substantially regular alternating sub-regions of high and low brightness.

6. The method of claim 4 where the analyzing step is comprised of:
determining whether the at least one images contain an image that is substantially darker in average luminosity than the other of the at least one images.

7. The method of claim 4 where the analyzing step is comprised of:
transmitting the at least one images to a computer in order to cause the computer to display the at least one images to an authorized operator; and
receiving from said computer a data value representing input from the authorized operator indicating a determination by the authorized operator.

8. The method of claim 1 where the verification step is comprised of:
receiving cellular telephone location data; and
determining that the cellular telephone location data is within a predetermined distance tolerance threshold to an address location represented by address data retrieved from a data record associated with the user.

9. The method of claim 1 further comprising:
receiving a first image data comprising a bar-code; and
determining whether the received first image data comprising a bar-code has been used before by the system by searching a database containing a plurality of received image data comprising bar-codes to see if the first received first image data is already present in the database.

10. A computer readable data storage device comprised of program code that when executed, causes a computer system to perform any one of the methods recited by claims 1-9.

11. A computer system comprised of a processor, memory and mass data storage device for authorizing transmission of digital content data comprising:
a module configured to receive from a user's computer data representing the location of the computer;
a module configured to verify that the received location is an authorized location;
a module configured to receive at least one image file of a media item cover, said media item being associated with the digital content;
a module configured to determine that the received at least one image file is a picture of the media item cover and not a picture of a reproduction or computer screen display of the media item cover to within a predetermined verification criteria tolerance; and in response to the determination, initiate a transmission of the digital content.

12. The system of claim 11 where the module configured to verify is further configured to:
receive GPS location data; and
determine that the GPS location data is within a predetermined distance tolerance threshold to an address location represented by address data retrieved from a data record associated with the user.

13. The system of claim 12 where the module configured to verify is further configured to:
receive data representing an address;
receive a credit card number, said credit card number being associated with an authorized billing address; and
determine if the received address data is comprised of data that matches the authorized billing address.

14. The system of claim 11 where the module configured to determine is further configured to:
analyze the at least one image file to determine if the image, when magnified, is consistent with a picture of an image displayed on a computer screen.

15. The system of claim 14 where the module configured to determine is further configured to:
determine whether at least one approximately white regions of the at least one image file, when magnified, contain substantially regular alternating sub-regions of high and low brightness.

16. The system of claim 14 where the module configured to determine is further configured to:
determine whether the at least one images contain an image that is substantially darker in average luminosity than the other of the at least one images.

17. The system of claim 14 further comprising a module configured to:
transmit the at least one images to a computer in order to cause the computer to display the at least one images to an authorized operator; and
receive from said computer a data value representing input from the authorized operator indicating a determination by the authorized operator.

18. The system of claim 11 where the module configured to verify is further adapted to:
receive cellular telephone location data; and
determine that the cellular telephone location data is within a predetermined distance tolerance threshold to an address location represented by address data retrieved from a data record associated with the user.

19. The system of claim 11 further comprising:
a module configured to receive a first image data comprising a bar-code; and
a module configured to determine whether the received first image data comprising a bar-code has been used before by the system by searching a database containing a plurality of received image data comprising bar-codes to see if the first received first image data is already present in the database.

20. The method of claim 1 further comprising:
receiving data comprising an electronic receipt of a purchase transaction for a copy of the digital content; and
verifying that the received electronic receipt is not invalid.

21. The system of claim 11 further comprising:
a module configured to receive data comprising an electronic receipt of a purchase transaction for a copy of the digital content and verify that the received electronic receipt is not invalid.
